(19) United States
(12) Patent Application Publication
(10) Pub. No.: US 2013/0090581 A1
(43) Pub. Date: Apr. 11, 2013

(54) MASSAGE DEVICE

(71) Applicant: YA-MAN LTD., Tokyo (JP)

(72) Inventor: Kentaro Yamazaki, Tokyo (JP)

(73) Assignee: YA-MAN LTD., Tokyo (JP)

(21) Appl. No.: 13/685,310

(22) Filed: Nov. 26, 2012

Related U.S. Application Data
(63) Continuation of application No. PCT/JP2011/061543, filed on May 19, 2011.

(30) Foreign Application Priority Data
May 26, 2010 (JP) 2010-120761

(51) Int. Cl. A61H 23/02

(52) U.S. Cl. CPC A61H 23/0218
USPC 601/81

(57) ABSTRACT

In the case of a prior art massage device, an adhesive pad is used to hold a vibrating motor on a human body. Therefore, there is a problem in that it is difficult, while transmitting vibrations, to knead or pinch a region being massaged. Disclosed is a massage device which massages a human body by transmitting vibrations to the same. This massage device is provided with vibrating motors which generate vibrations, and a pair of gloves which are worn on hands that apply massage and each of which is equipped with at least one of the vibrating motors.

### TECHNICAL FIELD

The present invention relates to a massage device which massages a human body by transmitting mechanical vibrations to the same.

### BACKGROUND ART

FIG. 6 shows a conventional massage device. This massage device is disclosed in the Patent Document 1.

As shown in FIG. 6 an adhesive pad such as urethane gel or silicon gel is denoted by 110, and a vibrating motor which functions as a vibration generation means is denoted by 120. The opposite surface of the adhesive face of the adhesive pad 110 contains a magnetic piece and the vibrating motor 120 has a magnetically adherable surface respectively, which are not shown in the figure.

As shown in FIG. 6 in order to alleviate stiffness in shoulders, the adhesive face of the adhesive pad 110 is adhered to an area affected by shoulder stiffness, and the vibrating motor 120 is placed on the adhesive pad 110. Thereafter, the magnetic piece of the adhesive pad 110 and the magnetically adherable surface of the vibrating motor 120 are adhered to each other so that the vibrating motor 120 is fixed on the affected area of shoulder stiffness.

Subsequently, when a power switch is turned on to vibrate the vibrating motor 120, the vibrations of the vibrating motor 120 are transmitted to the area affected by shoulder stiffness, resulting in the alleviation of the shoulder stiffness. To summarize, referring to FIG. 6 the vibrating motor 120 is fixed on a given part of the body so as to produce vibrations by means of the adhesive pad 110 equipped with the magnetic piece in order to produce massage therapy.

### PRIOR ART

### Patent Document 1

Japanese Patent Application Laid-Open No. 2007-44319

### SUMMARY OF THE INVENTION

### Technical Problems

In the case of the massage device of FIG. 6 the adhesive pad is utilized to hold the vibrating motor on a given part of the body. Therefore, it is difficult to knead or pinch a region being massaged while concurrently transmitting vibrations, and it ends up merely transmitting vibrations.

Moreover, since the adhesive pad is utilized to hold the vibrating motor on the body, there is a problem that the vibrations cannot be transmitted deeply inside the body. Instead, they are transmitted only to the surface part of the region being massaged.

Furthermore, since the adhesive pad is utilized to hold the vibrating motor on the body, there is also a problem that the vibrations cannot be transmitted to a region where the adhesive pad is difficult to be adhered to and accordingly the vibrating motor is not accommodating such as underneath clothes or on head hair.

To solve the problems described above, the present invention enables one to transmit vibrations to a region being massaged while concurrently kneading or pinching the same region so that the massaging effect can be enhanced.

The present invention also enables one to transmit vibrations to not only the surface part of the region being massaged but also deeply inside of the body without difficulty so that the massaging effect can be enhanced.

Moreover, the present invention removes restrictions on the possible regions to get massaged. The vibration generation means can be placed on a region that is difficult to be massaged, such as underneath clothes or on head hair. Therefore, it becomes possible to apply massage anywhere on the body.

The massage device according to one embodiment of the present invention is comprised of a glove means which is worn on hands that apply the massage, and a coin-shaped vibration generation means which generates vibrations. The glove means are equipped with a plurality of the coin-shaped vibration generation means. The coin-shaped vibration generation means are secured to the glove means by their coin face.

The massage device according to one embodiment of the present invention is provided with a vibration generation means which are coin-shaped vibrating motors. The vibrating motor is comprised of a shaft made of elastic material, a circular plate eccentrically fixed to the shaft, a plurality of coils which are fixed on the circular plate, a magnet which is fixed on a part of the circular plate, and a magnet which is fixed on a case and is located a predetermined distance apart from the plurality of the coils. Rotations of the said circular plate based on the eccentricity of the center of gravity generates vibrations in the radial direction, while concurrently generating vibrations in the axial direction caused by the adsorption between the magnet fixed on the circular plate and the magnet fixed on the case.

The massage device according to one embodiment of the present invention is comprised of the glove means which are equipped with the vibration generation means on the fingertips side of them.

The massage device according to one embodiment of the present invention comprises a plurality of the vibration generation means having a vibration control means which allows the vibrations to be generated sequentially and separately.

The massage device according to one embodiment of the present invention comprises the vibration generation means having a vibration control means which produces changes in the level of the vibrations periodically.

One embodiment of the present invention is comprised of the glove means which are worn on hands that apply massage and coin-shaped vibration generation means which generate vibrations. The glove means are equipped with a plurality of the vibration generation means. By securing the coin faces of the vibration generation means to the glove means, it becomes possible to make the gloves lighter and less bulky. Further, because the glove means are worn on the hands, it is possible to knead or pinch a region being massaged without difficulty while concurrently transmitting vibrations from the vibration generation means, which enhances the massaging effect.

In one embodiment of the present invention, the vibration generation means is a coin-shaped vibrating motor which is comprised of a shaft made of elastic material, a circular plate eccentrically fixed to the shaft, a plurality of coils which are fixed on the circular plate, a magnet which is fixed on a part of the circular plate, and a magnet which is fixed on the case and is locating predetermined distance apart from the plurality of the coils. Rotations of the said circular plate based on the eccentricity of the center of gravity generates vibrations in the radial direction, while concurrently generating vibrations in the axial direction caused by the adsorption between the magnet fixed on the circular plate and the magnet fixed on the case. Accordingly, multiple vibrations are generated so that the massaging effect can be enhanced.

The glove means of the present invention are equipped with the vibration generation means on the fingertips side of them so that it becomes possible to use fingertips of the glove means to apply massage while concurrently transmitting the vibrations generated by the vibration generation means, resulting in the capability of providing a variety of massage therapy.

Another embodiment of the present invention further comprises a vibration control means capable of controlling vibrations that are generated sequentially and separately from the plurality of vibration generation means, so that it becomes possible to create vibrations that are transmitted without having to move hands or fingers, resulting in the application of massage therapy along the lines of trigger points of the body.

Another embodiment of the present invention further comprises a vibration control means which periodically produces changes in the level of the vibrations generated from the vibration generation means, making it possible to produce a variety of vibrational patterns, providing a varied massage therapy.

### BRIEF DESCRIPTION OF THE DRAWINGS

FIG. 1 is an appearance diagram of the massage device according to the embodiment 1 of the present invention.

FIG. 2 is a block diagram which illustrates the internal constitution of the massage device according to the embodiment 1 of the present invention.

FIG. 3 is an explanatory diagram which illustrates an example of how to use the massage device according to the embodiment 1 of the present invention.

FIG. 4 is a configuration diagram which illustrates an example of a variation of how to arrange vibrating motors.

FIG. 5 is a cross-section view of a coin-shaped vibrating motor,

(a) shows a state that vibrations are generated by rotating an eccentric weight, while

(b) shows a state that vibrations are generated toward normal direction of the coin face in parallel with the radial direction.

FIG. 6 is an explanatory diagram which illustrates an example of how to use the conventional massage device.

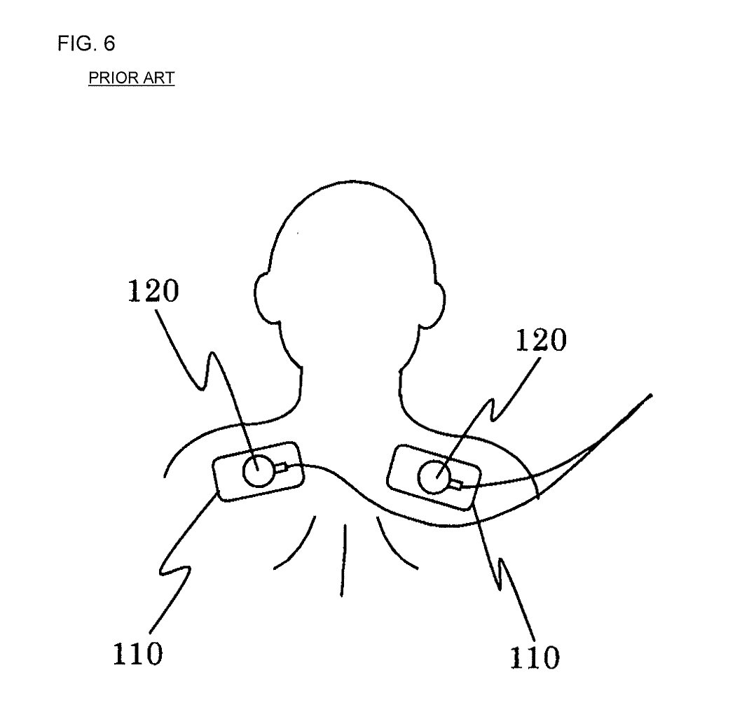

### DETAILED DESCRIPTION OF THE INVENTION

Hereinafter, an embodiment of this invention will be concretely described with reference to the drawings. In each of the drawings, same numerical symbols are used to the same constitutions or corresponding constitutions.

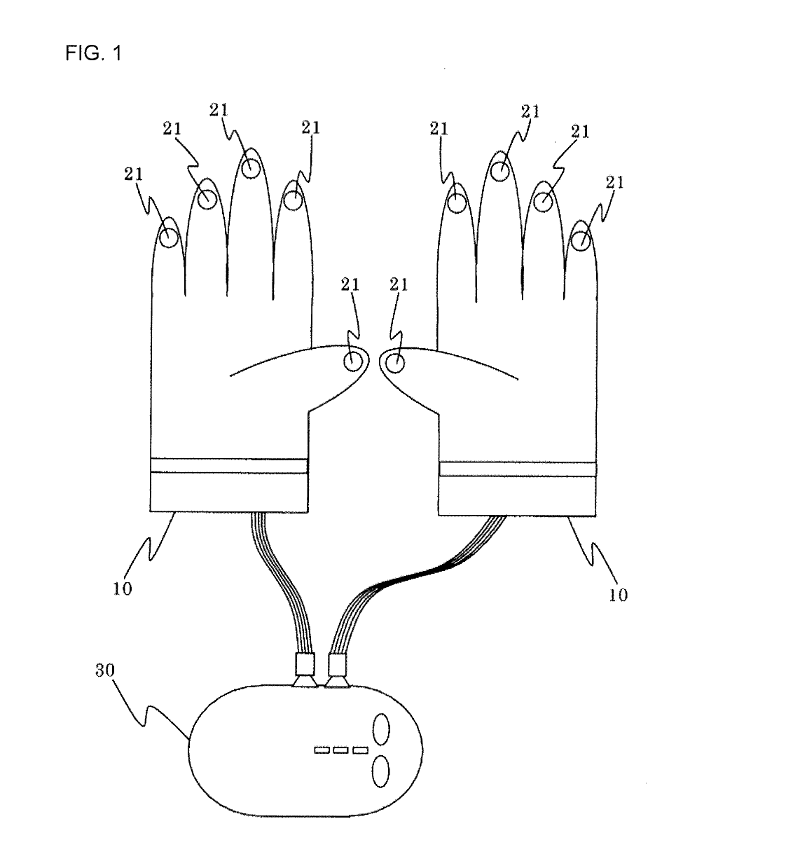

FIG. 1 is an appearance diagram of the massage device according to the first embodiment of the present invention.

In FIG. 1, a pair of gloves (glove means) which are worn on the right hand and the left hand of a user are denoted by 10. Coin-shaped vibrating motors (vibration generation means) which are placed on regions corresponding to balls of thumbs, forefingers, middle fingers, annular fingers and little fingers of the gloves 10 are denoted by 21. A controller of the massage device is denoted by 30. It is possible to independently place a downsized controller 30 on each one of the gloves so as to upgrade the operational flexibility. Herein, a ball of a finger intends a region where finger pattern is found. Each of the names of regions on the gloves 10 corresponds to the part names of hands hereinafter.

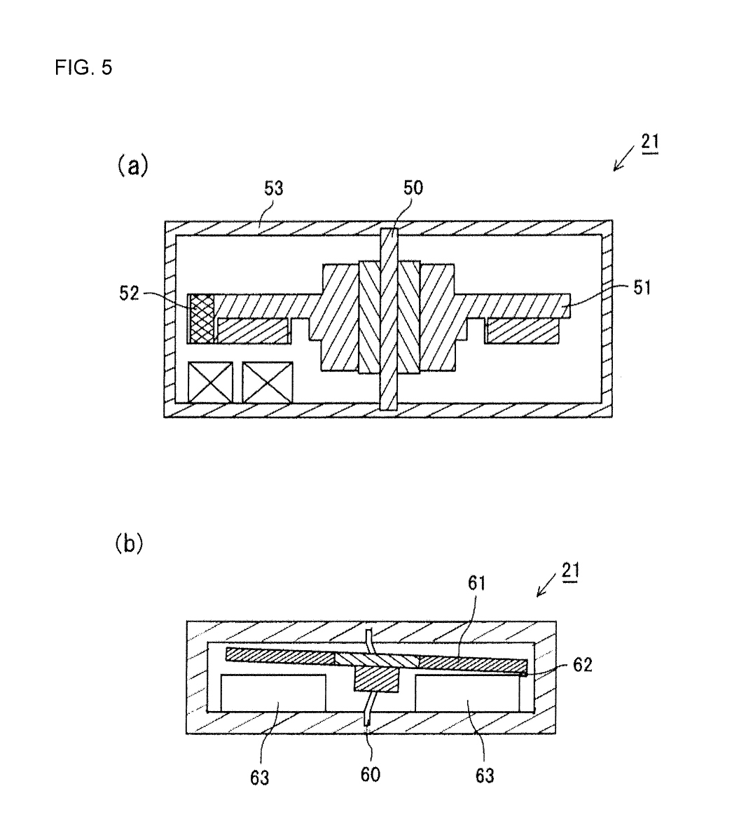

The massage device shown in FIG. 1 has a feature in a way that the gloves 10 are equipped with the vibrating motors 21. The vibrating motors 21 are the materials which are often utilized as vibrators for mobiles, and are capable of employing a variety of types of vibration generation, not only the way which rotates an eccentric weight around a motor shaft (shown in FIG. 5(a)), but also the way in which vibrations are generated toward a normal direction of the coin face in parallel with the radial direction, and so on.

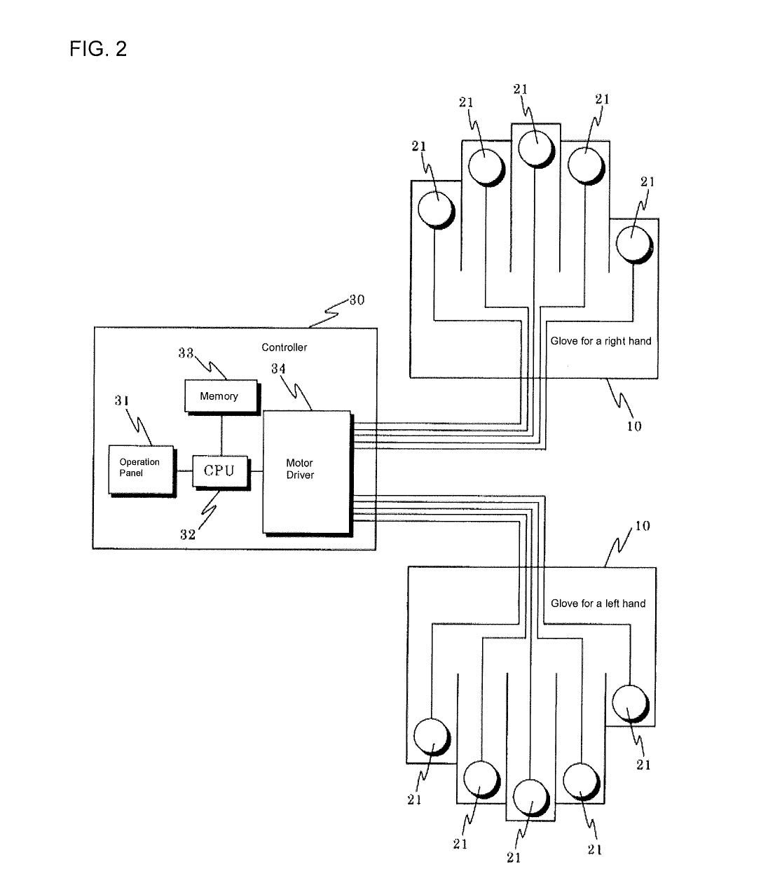

In FIG. 5(a), an oscillator 51 rotates around a motor shaft 50. Since the oscillator 51 is equipped with an eccentric weight 52, the whole of the case 53 vibrates through the motor shaft 50 around which the oscillator 51 rotates. It is ideal to set up the case 53 in the shape of a coin which is about 10 millimeters in outside diameter, about 3 to 5 millimeters in thickness, and weighs about 1.0 gram. This case is bonded with an adhesion bond to a certain place of the gloves 10 and wired to the controller 30 as in FIG. 2.

FIG. 5(b) shows another example of the vibrating motor which generates vibrations toward a normal direction of the coin face in parallel with the radial direction. Here, a circular plate 61 is eccentrically fixed to a shaft 60 made of elastic material. The circular plate 61 is equipped with a plurality of coils. Since a rotative force is generated between the circular plate 61 and magnets 63 which are placed opposite to the circular plate 61, the circular plate 61 rotates around the shaft 60 when it is energized. At this time, due to a magnet 62 placed on a part of the circular plate 61, a force which intergrades in the axial direction affects the circular plate 61 so that the circular plate 61 vibrates in the axial direction i.e. normal direction of the coin face concurrently vibrating in the radial direction by eccentricity of the center of gravity. When these kind of vibrating motors which generate multiple vibrations are fixed to the gloves, it is possible to further enhance the massaging effect.

The vibrating motors 21 are bonded with an adhesion bond or the like to balls of fingers of the gloves 10. Although FIG. 1 shows an embodiment wherein the vibrating motors 21 are placed outside of the gloves 10, it is possible to place the vibrating motors 21 inside of the gloves 10 i.e. the side in which hands of the user are inserted. As the coin-shaped vibrating motors are employed, it becomes possible to make the gloves 10 lighter and less bulky, resulting in a more practical embodiment of the massage device.

FIG. 2 shows a block configuration according to the first embodiment of the massage device of the present invention.

In FIG. 2, the controller 30 is comprised of the following parts: An operation panel which operates the massage device is denoted by 31; a CPU (vibration control means) which controls the massage device is denoted by 32; a memory which stores the program and the various settings of the massage device is denoted by 33; and a motor driver (vibration control means) which activates the respective vibrating motors 21 is denoted by 34.

Hereinafter it is explained how the device is used. When a user of the massage device wears the gloves 10 on their hands, the user starts up the massage device by operating the operation panel 31. The CPU 32 activates the respective vibrating motors 21 by means of the motor driver 34 based on a program of a normal mode which is stored in the memory 33. Subsequently, when the vibrations are generated from the vibrating motors 21, the user applies the gloves 10 to a body region to get massaged in order to transmit the vibrations and concurrently knead or pinch the same region by the gloves 10.

As described above, as the gloves 10 are equipped with vibrating motors 21 which are worn on hands that apply massage and transmit vibrations to the body region to get massaged while concurrently kneading or pinching the same region by the gloves 10, so that it becomes possible to enhance the massaging effect.

Also, since it is possible to compress the vibrating motors 21 to the region being massaged thanks to the gloves 10, the vibrations can be transmitted to not only the surface part of the body region being massaged but also deeply inside of the body without difficulty, enhancing the massaging effect.

Furthermore, thanks to the gloves 10, it is possible to place the vibrating motors 21 on body regions such as underneath clothes or on head hair and transmit vibrations without difficulty. Accordingly, it becomes possible to reflect the massaging effect into the regions which are conventionally considered to be difficult to get massaged without difficulty.

In addition, the gloves 10 can be worn not only by the user themself but also by an assistant when it is used.

In addition to what has been described above, below is another possible method of using the device.

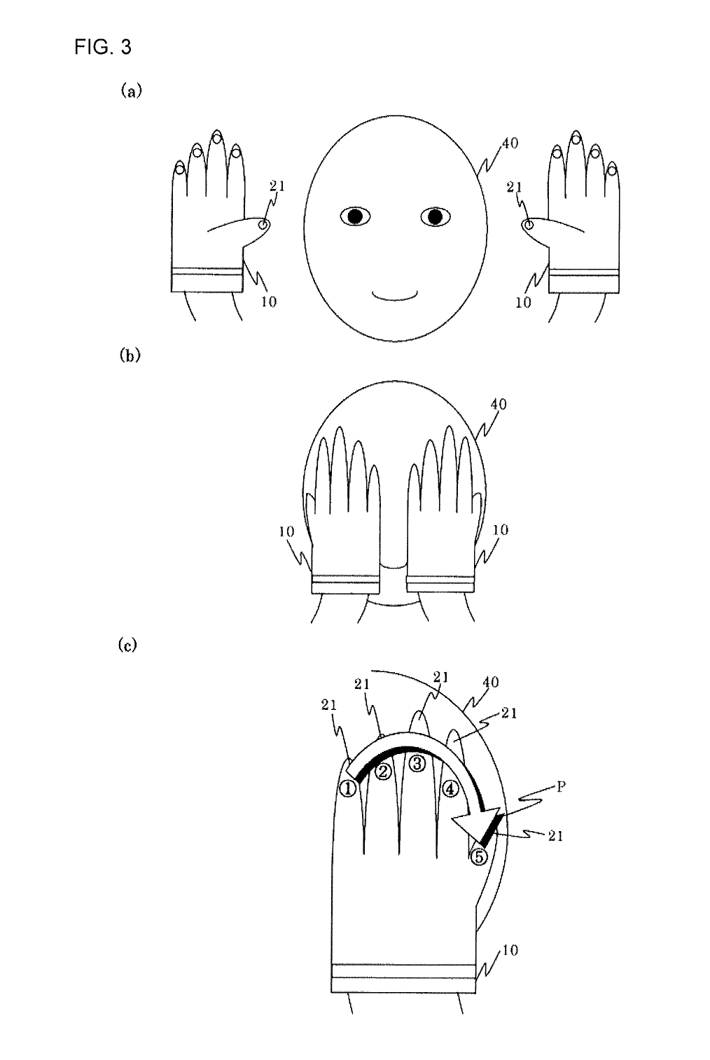

FIG. 3 is an explanatory diagram which illustrates an example of how to use the massage device according to the first embodiment of the present invention. It illustrates a case that a user applies massage to their own face 40 by using the massage device. However, the massage can be applied not only to the face but also to other parts of the body.

FIG. 3(b) shows a state when the user who wears the gloves 10 on hands as shown in FIG. 3(a) put the palm sides of the gloves 10 onto the face 40, selecting vibration modes in series. In the state of FIG. 3(b), the respective vibrating motors 21 lies almost along the line of lymph nodes from around eyes to in front of ears. As the circled numbers in FIG. 3(c) indicate, the CPU 32 activates the respective vibrating motors 21 in the order of fingers, i.e. little fingers, annular fingers, middle fingers, forefingers, thumbs, little fingers, annular fingers, middle fingers, forefingers, thumbs (and repeat), to generate vibrations in a series by means of the motor diver 34 for the vibration duration time of Δt, based on a program of a sequential mode which is remembered in the memory 33.

In this way, as the palms of the gloves 10 are opened and put over the face 40, they sequentially vibrate the vibrating motors 21 in the order from little fingers to thumbs i.e. from the lymph nodes around the eyes to the lymph nodes in front of the ears of face 40 along the flow of lymph, it becomes possible to circulate the lymph in the direction of the arrow P in FIG. 3(c) without moving the hands or fingers, resulting in the capability of the highly effective lymphatic massage from a health or aesthetic standpoint.

The order, timing of the beginning, duration time or level of the vibrations of the respective vibrating motors 21 are not limited to the cases shown in FIG. 3. For example, referring to FIG. 3, it is possible to divide the fingers into two groups, one of which is a combination of little fingers and annular fingers and the other is a combination of middle fingers, fore fingers and thumbs. A pattern that sequentially vibrates the vibrating motors 21 of the two groups is possible. That is to say, it can be flexibly utilized depending on the positional relation between the flow of lymph and the respective vibrating motors 21 or the intention and preference of the user, by changing the setting of the program of the memory 33 by means of the operation panel 31. Further, it is possible to sequentially vibrate the respective vibrating motors 21 along not only the flow of lymph but also other flows of bodily fluid such as blood.

However, it is needless to say that the respective vibrating motors 21 can be sequentially vibrated irrespective of flows of bodily fluid, allowing one to transmit vibrations with directionality on the body, resulting in the capability of applying massage therapy without need of moving hands or fingers.

Although the case that the vibrating motors 21 are fixed to the balls of fingers of the gloves 10 has been described above, it is not necessary to place the vibrating motors 21 on the balls of fingers of the gloves 10.

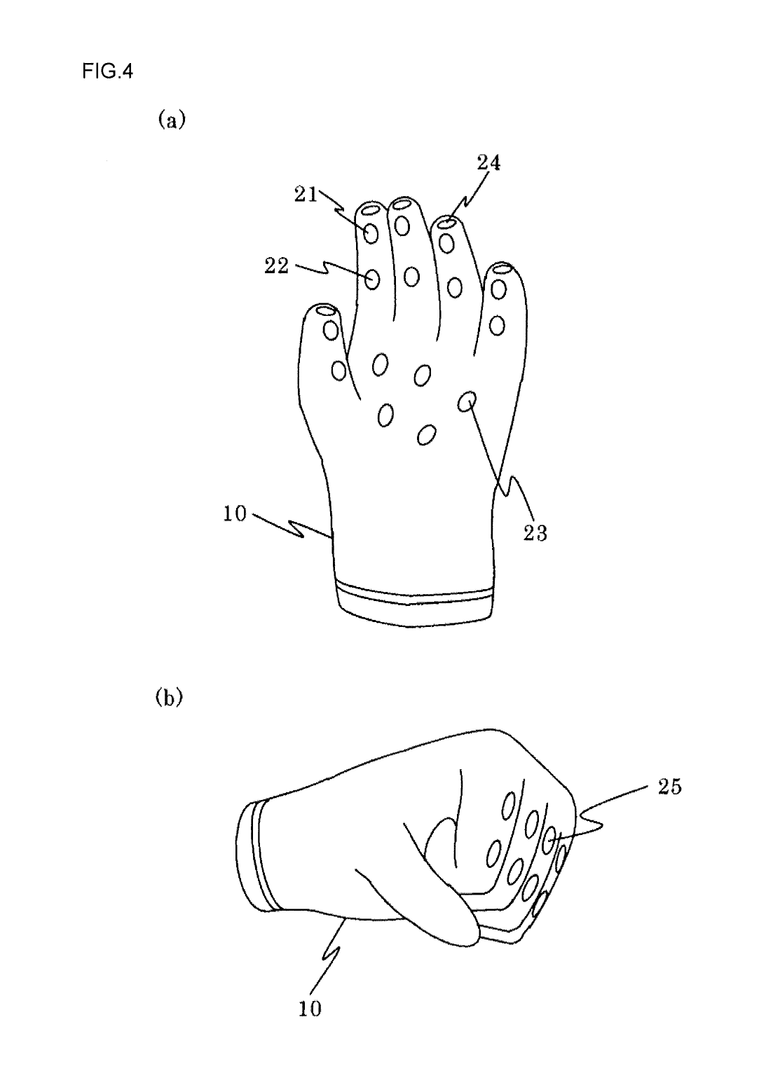

As shown in FIG. 4, a variety of arrangement is possible.

FIG. 4 is a configuration diagram which illustrates a variation of vibrating motors arrangement.

In FIGS. 4(a) and (b), the vibrating motors (vibration generation means) placed on the palm side of fingers of the glove 10 are denoted by 22. Here, the vibrating motors 22 are placed not on the balls of fingers, but on regions between the balls of fingers and the bases of fingers. In addition, the vibrating motors (vibration generation means) placed on the palm of the glove 10 are denoted by 23, the vibrating motors (vibration generation means) placed on the fingertips of the glove 10 are denoted by 24, and the vibrating motors (vibration generation means) placed on the back-of-hand side of fingers of the glove 10 are denoted by 25.

As described above, it is possible to arrange the vibrating motors 21 to 23 on the palm of the glove 10, the vibrating motors 24 on the fingertips of the glove 10, and the vibrating motors 25 on the back-of-hand side of the glove 10, respectively. Accordingly, it becomes possible to use the palm, fingertips and back-of-hand side of the glove 10 while concurrently transmitting the vibrations of the vibrating motors 21 to 25, resulting in the capability of providing a variety of massage therapy. However, it is needless to say that the arrangement shown in FIG. 4 is just an example. It is possible to arrange the vibrating motors 21 to 25 on other locations aside from the locations shown in FIG. 4.

Although the embodiment with the vibrating motors 21 to 25 has been described above, it is possible to constitute the vibration generation means by utilizing voice coils or magnetostrictive materials instead of the vibrating motors 21 to 25.

Furthermore, it is possible that the CPU 32 and the motor driver 34 control vibrations to be generated by the vibrating motors 21 to 25 such that the vibrational amplitudes are modulated by periodic functions such as sine wave, triangle wave, saw-tooth wave, square wave or the like. By periodically producing changes in the level of the vibrations of the vibrating motors 21 to 25, it becomes possible to produce a variety of vibrational patterns, resulting in a varied massage therapy.

It is not necessary to provide the gloves 10 for both hands. Either one for a right hand or a left hand of the gloves 10 is sufficient. In addition, it is not necessary to form the glove as a five-finger glove.

Moreover, a plurality of the vibrating motors 21 to 25 are not necessarily needed. With a single vibrating motor, it is essentially possible to conduct a massage therapy other than the sequential vibration mode shown in FIG. 3. However, it is ideal to provide a plurality of the vibrating motors 21 to 25, so that the vibrations can be transmitted from a plurality of the vibrating motors 21 to 25, resulting in the enhancement of the massaging effect.

Furthermore, it is not necessary to provide the gloves 10 and the controller 30 as separate bodies. When the controller 30 is downsized, the glove 10 and the controller 30 can be constituted as a combined one, resulting in the enhancement of the massage device.

As described above, according to the first embodiment of the massage device of the present invention which massages a human body by transmitting vibrations, it is possible to enhance the massaging effect. This enhancement can be achieved since the device comprises vibrating motors 21 to 25 which generate vibrations and a pair of gloves 10 which are worn on the hands that apply massage, each of which is equipped with at least one of the vibrating motors 21 to 25, allowing a user to knead or pinch a region being massaged without difficulty. In addition, due to the gloves 10 being worn on the hands, it becomes possible to compress the vibrating motors 21 to 25 on the body so that the vibrations can be transmitted to not only the surface part of the body region being massaged but also deeply inside of the body without difficulty, resulting in the enhancement of the massaging effect. Furthermore, due to the gloves 10 being worn on the hands, the vibrating motors 21 to 25 can be placed on body regions such as underneath clothes or on head hair without difficulty, making massage possible in body regions which are conventionally considered difficult to get massaged.

In addition, according to the first embodiment, as the gloves 10 are equipped with the vibrating motors 21 to 23 on the palm side of them, it becomes possible to use palms of the gloves 10 for applying massage while concurrently transmitting the vibrations generated by the vibrating motors 21 to 23, resulting in the capability of providing a variety of massage therapy.

Furthermore, according to the first embodiment, as the gloves 10 are equipped with the vibrating motors 24 on the fingertips side of them, it becomes possible to use fingertips of the gloves 10 for applying massage while concurrently transmitting the vibrations generated by the vibrating motors 24, resulting in the capability of providing a variety of massage therapy.

Furthermore, according to the first embodiment, as the gloves 10 are equipped with the vibrating motors 25 on the back-of-hand side of them, it becomes possible to use back-of-hand of the gloves 10 for applying massage while concurrently transmitting the vibrations generated by the vibrating motors 25, resulting in the capability of providing a variety of massage therapy.

Furthermore, according to the first embodiment, as the gloves 10 are equipped with a plurality of the vibrating motors 21 to 25, it becomes possible to transmit vibrations from a plurality of the vibrating motors 21 to 25, further enhancing the massaging effect.

Furthermore, according to the first embodiment, as the CPU 32 and the motor driver 34 which control vibrations that are generated sequentially from a plurality of the vibrating motors 21 to 25, it becomes possible to transmit vibrations with directionality on the body, resulting in the capability of applying massage therapy without need of moving hands or fingers.

Furthermore, according to the first embodiment, as the CPU 32 and the motor driver 34 which periodically produce changes in the level of the vibrations generated from the vibrating motors 21 to 25, it becomes possible to produce a variety of vibrational patterns, resulting in the capability of providing a varied massage therapy.

Furthermore, according to the first embodiment, as the vibrating motors 21 to 25 are coin-shaped vibrating motors, it becomes possible to make the gloves 10 lighter and less bulky, resulting in a more practical embodiment of the massage device.

Although the vibrating motors are pointed out as the vibration generation means in the embodiment described above, the present invention is not restricted to this embodiment. An electrodynamic vibration generation equipment wherein an iron sheet is drawn and repelled by applying alternate current to a coil, or a vibration generation equipment wherein a magnetostrictive material is transformed by applying alternate current to a coil, are also possible.

1. A massage device comprising a glove means which is worn on hands that apply massage and a coin-shaped vibration generation means which generate vibrations, and
said glove means are characterized in that the coin faces of a plurality of the coin-shaped vibration generation means are secured to said glove means.

2. The massage device of claim 1, wherein the vibration generation means is a coin-shaped vibrating motor comprising:
a shaft made of elastic material,
a circular plate eccentrically fixed to the said shaft, a plurality of coils which are fixed on the circular plate, a magnet which is fixed on a part of the circular plate, and
a magnet which is fixed on a case and is locating predetermined distance apart from a plurality of the coils,
and the rotations of the said circular plate are based on the eccentricity of the center of gravity to generate vibrations in the radial direction, while concurrently generating vibrations in the axial direction by adsorption between the magnet fixed on the circular plate and the magnet fixed on the case.

3. The massage device of claim 1, wherein the glove means are equipped with the vibration generation means on the fingertips side of them.

4. The massage device of claim 2, wherein the glove means are equipped with the vibration generation means on the fingertips side of them.

5. The massage device of claim 1 wherein a vibration control means which controls vibrations that are generated sequentially from a plurality of the said vibration generation means is further comprised.

6. The massage device of claim 2 wherein a vibration control means which controls vibrations that are generated sequentially from a plurality of the said vibration generation means is further comprised.

7. The massage device of claim 3 wherein a vibration control means which controls vibrations that are generated sequentially from a plurality of the said vibration generation means is further comprised.

8. The massage device of claim 4 wherein a vibration control means which controls vibrations that are generated sequentially from a plurality of the said vibration generation means is further comprised.

9. The massage device of claim 1 wherein the vibration control means which periodically produces changes in the level of the vibrations that are generated from the vibration generation means is further comprised.

10. The massage device of claim 2 wherein the vibration control means which periodically produces changes in the level of the vibrations that are generated from the vibration generation means is further comprised.

11. The massage device of claim 3 wherein the vibration control means which periodically produces changes in the level of the vibrations that are generated from the vibration generation means is further comprised.

12. The massage device of claim 4 wherein the vibration control means which periodically produces changes in the level of the vibrations that are generated from the vibration generation means is further comprised.
